(19) United States
(12) Patent Application Publication
(10) Pub. No.: US 2013/0135436 A1
(43) Pub. Date: May 30, 2013

(54) IMAGING APPARATUS

(71) Applicants: Masahiro Yamada, Osaka (JP); Hiroto Yamaguchi, Osaka (JP); Nao Kataoka, Osaka (JP)

(72) Inventors: Masahiro Yamada, Osaka (JP); Hiroto Yamaguchi, Osaka (JP); Nao Kataoka, Osaka (JP)

(73) Assignee: PANASONIC CORPORATION, Osaka (JP)

(21) Appl. No.: 13/814,251

(22) PCT Filed: Jun. 24, 2011
(86) PCT No.: PCT/JP2011/003619

§ 371 Date: Feb. 5, 2013

(30) Foreign Application Priority Data
Aug. 6, 2010 (JP) 2010-177224

(51) Int. Cl. H04N 13/00

(52) U.S. Cl. CPC H04N 13/0029
USPC 348/43

(57) ABSTRACT

An imaging apparatus according to the present invention includes an imaging element that captures a subject image and generates video data, an image processor that executes a white balance process on the video data generated by the imaging element based on a predetermined algorithm, a connecting portion connectable with a 3D conversion lens that can simultaneously forming a subject image for left eye and a subject image for right eye on the imaging element, and a detector that detects whether the 3D conversion lens is connected to the connecting portion, wherein the image processor executes the white balance process based on different algorithms in a case where the 3D conversion lens is connected to the connecting portion and a case where the 3D conversion lens is not connected to the connecting portion according to a detected result of the detector.

### TECHNICAL FIELD

The present invention relates to an imaging apparatus capable of adjusting white balance.

### BACKGROUND ART

Patent Document 1 discloses an imaging apparatus. The imaging apparatus can be connected with a stereo adapter capable of simultaneously forming a subject image for left eye and a subject image for right eye on an imaging element.

### PRIOR ART DOCUMENT

### Patent Document

Patent Document 1: JP-A-2003-47028

### SUMMARY OF INVENTION

### Problems to be Solved by the Invention

In a subject image to be formed on an imaging element via a stereo adapter, color shift such as blue fogging or red fogging occasionally occurs due to characteristics of an optical system (lens) composing the stereo adapter. For this reason, when the stereo adapter is attached to the imaging apparatus, a suitable white balance process cannot be executed due to the color shift.

It is an object of the present invention to provide an imaging apparatus that can execute a suitable white balance process whether or not a stereo adapter (3D conversion lens) is attached.

### EFFECTS OF THE INVENTION

In order to solve the problem, an imaging apparatus according to the present invention includes an imaging element that captures a subject image and generates video data, an image processor that executes a white balance process on the video data generated by the imaging element based on a predetermined algorithm, a connecting portion connectable with a 3D conversion lens that can simultaneously forming a subject image for left eye and a subject image for right eye on the imaging element, and a detector that detects whether the 3D conversion lens is connected to the connecting portion, wherein the image processor executes the white balance process based on different algorithms in a case where the 3D conversion lens is connected to the connecting portion and a case where the 3D conversion lens is not connected to the connecting portion according to a detected result of the detector.

According to the present invention, the white balance process can be executed based on different algorithms in cases where the 3D conversion lens is connected to the connecting portion and a case where the 3D conversion lens is not connected to the connecting portion. As a result, the suitable white balance process can be executed whether or not the 3D conversion lens is attached.

### BRIEF DESCRIPTION OF DRAWINGS

FIG. 1 is a perspective view illustrating a state that a 3D conversion lens 500 is attached to a digital video camera 100 according to a first embodiment.

FIG. 2 is a block diagram illustrating a configuration of the digital video camera 100 according to the first embodiment.

FIG. 3 is a flowchart for describing an auto white balance control process according to the first embodiment.

FIG. 4 is a schematic diagram for describing division of video data according to the first embodiment.

FIG. 5 is a diagram for describing calculation of a position of white in a 2D video signal according to the first embodiment.

FIG. 6 is a diagram for describing calculation of a position of white in a 3D video signal according to the first embodiment (1).

FIG. 7 is a diagram for describing the calculation of the position of white in the 3D video signal according to the first embodiment (2).

FIG. 8 is a schematic diagram describing the calculation of the position of white in the 3D video in the digital video camera according to a second embodiment.

FIG. 9 is a flowchart for describing the auto white balance control process according to the second embodiment.

### MODE FOR CARRYING OUT THE INVENTION

### First Embodiment

A first embodiment where the present invention is applied to a digital video camera will be described with reference to the drawings.

1. Outline

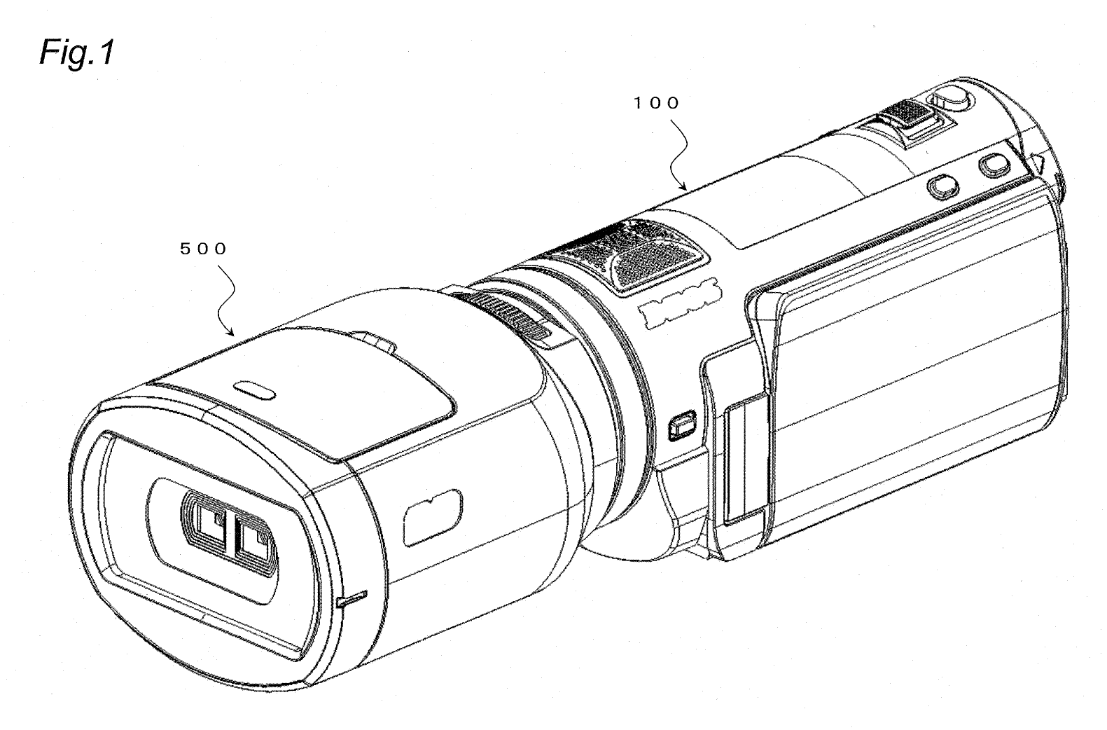

An outline of the digital video camera 100 according to this embodiment will be described with reference to FIG. 1. FIG. 1 is a perspective view illustrating a state that a 3D conversion lens 500 is mounted to the digital video camera 100.

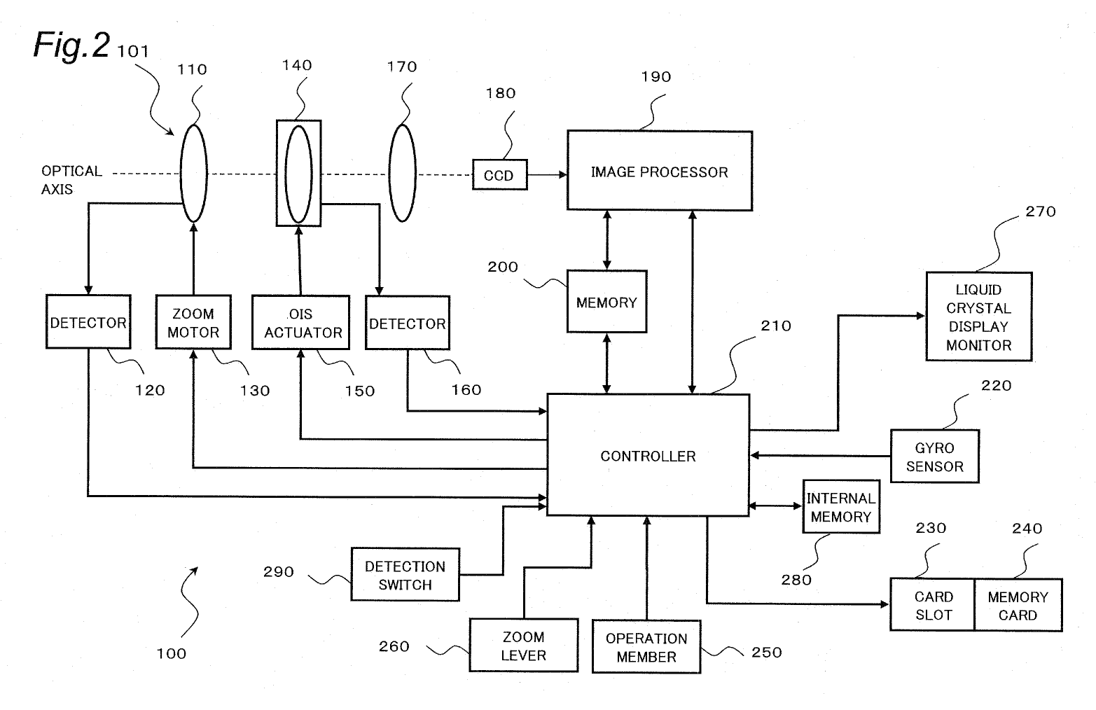

The 3D conversion lens 500 is attachable/detachable to/from a connecting portion 640 (mounting portion) of the digital video camera 100. The digital video camera 100 can magnetically detect the connection (mounting) of the 3D conversion lens 500 by means of a detection switch 290 (see FIG. 2).

The 3D conversion lens 500 has a lens for right eye that guides light for forming a subject image for right eye in a 3D (three dimensions) video to an optical system of the digital video camera 100, and a lens for left eye that guides light for forming a subject image for left eye to the optical system.

The light incident via the 3D conversion lens 500 is incident on a CCD image sensor 180 of the digital video camera 100. As a result, for example, as a side-by-side type 3D video, a subject image for right eye and a subject image for left eye are simultaneously formed on the CCD image sensor 180.

2. Configuration

An electrical configuration of the digital video camera 100 according to the embodiment will be described with reference to FIG. 2. FIG. 2 is a block diagram illustrating a configuration of the digital video camera 100. The digital video camera 100 has an optical system 101, the CCD image sensor 180, an image processor 190, a liquid crystal display monitor 270, a detector 120, a zoom motor 130, an OIS actuator 150, the detector 160, a memory 200, a controller 210, a zoom lever 260, an operation member 250, an internal memory 280, a gyro sensor 220, a card slot 230, and a detection switch 290. In the digital video camera 100, the CCD image sensor 180 captures a subject image formed by the optical system 101. Video data generated by the CCD image sensor 180 is subject to various processes in the image processor 190, and is stored in the memory card 240. Further, the video data stored in the memory card 240 can be displayed on the liquid crystal display monitor 270. The configuration of a digital video camera 100 will be concretely described below.

The optical system 101 of the digital video camera 100 includes a zoom lens 110, an OIS 140, and a focus lens 170. The zoom lens 110 moves along an optical axis of the optical system 101 to be capable of enlarging or reducing a subject image. The focus lens 170 moves along the optical axis of the optical system 101 to adjust a focus of the subject image.

The OIS 140 has a correcting lens that can move in a plane vertical to the optical axis. The OIS 140 drives the correcting lens to a direction where a shake of the digital video camera 100 is cancelled to reduce a shake of a subject image.

The zoom motor 130 drives the zoom lens 110. The zoom motor 130 may be realized by a pulse motor, a DC motor, a linear motor, a servo motor or the like. The zoom motor 130 may drive the zoom lens 110 via a cam mechanism or a mechanism such as a ball screw. The detector 120 detects a position on the optical axis where the zoom lens 110 is present. The detector 120 outputs a signal relating to the position of the zoom lens through a switch such as a brush according to the transfer of the zoom lens 110 to an optically axial direction.

The OIS actuator 150 drives the correcting lens in the OIS 140 in a plane vertical to the optical axis. The OIS actuator 150 can be realized by a planar coil or an ultrasonic motor. The detector 160 detects a moving distance of the correcting lens in the OIS 140.

The CCD image sensor 180 captures a subject image formed by the optical system 101 composed of the zoom lens 110 to generate video data. The CCD image sensor 180 performs various operations such as exposure, transfer and an electronic shutter.

The image processor 190 executes the various processes on video data generated by the CCD image sensor 180. The image processor 190 generates video data to be displayed on the liquid crystal display monitor 270 or generates video data to be again stored in the memory card 240. For example, the image processor 190 executes various processes such as gamma correction, white balance correction and a scratch correction on the video data generated by the CCD image sensor 180. Further, the image processor 190 compresses the video data generated by the CCD image sensor 180 according to a compressing format in conformity with the H.264 standards or the MPEG2 standards. The image processor 190 decodes the compressed video data. The image processor 190 can be realized by a DSP or a microcomputer.

The controller 210 is a control unit for controlling the digital video camera entirely. The controller 210 can be realized by a semiconductor element. The controller 210 may be composed of only hardware or a combination of hardware and software. The controller 210 can be realized by a microcomputer.

The memory 200 functions as a work memory of the image processor 190 and the controller 210. The memory 200 can be realized by, for example, a DRAM or a ferroelectric memory.

The liquid crystal display monitor 270 can display video represented by video data generated by the CCD image sensor 180 and video represented by video data read from the memory card 240.

The gyro sensor 220 is composed of an oscillation material such as a piezoelectric element. The gyro sensor 220 converts a force caused by a Coriolis force at a time of oscillating the oscillation material such as the piezoelectric element at a constant frequency into a voltage to obtain angular velocity information. The digital video camera 100 obtains the angular velocity information from the gyro sensor 220 and drives the correcting lens in the OIS 140 to a direction where the shake is cancelled to correct a camera shake caused by the user.

The memory card 240 is attachable to the card slot 230. The card slot 230 can be mechanically and electrically connected to the memory card 240. The memory card 240 contains a flash memory or a ferroelectric memory capable of storing data.

The internal memory 280 is composed of a flash memory or a ferroelectric memory. The internal memory 280 stores a control program or the like for entirely controlling the digital video camera 100.

The operation member 250 is a member for receiving operations from the user. The zoom lever 260 is a member for receiving an instruction for changing a zoom magnification from the user.

The detection switch 290 can magnetically detect that the 3D conversion lens 500 is attached (connected) to the digital video camera 100. When the detection switch 290 detects that the 3D conversion lens 500 is attached, it sends a signal indicating that the 3D conversion lens 500 is attached to the controller 210. As a result, the controller 210 can detect that the 3D conversion lens 500 is attached to and detached from the digital video camera 100.

3. Operation

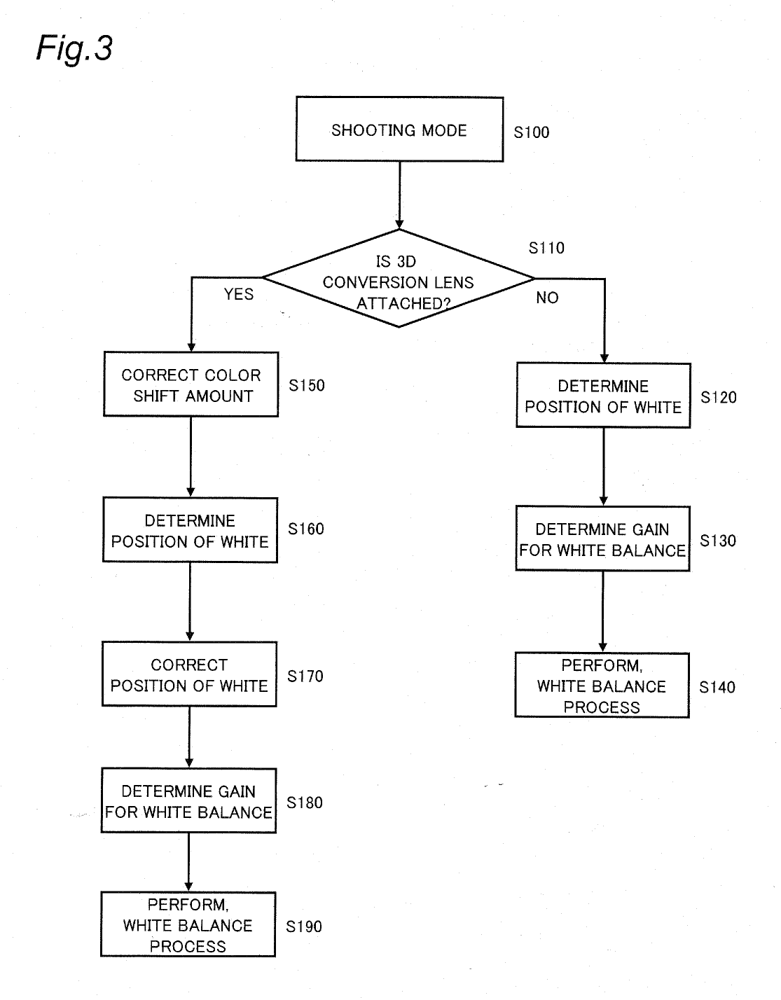

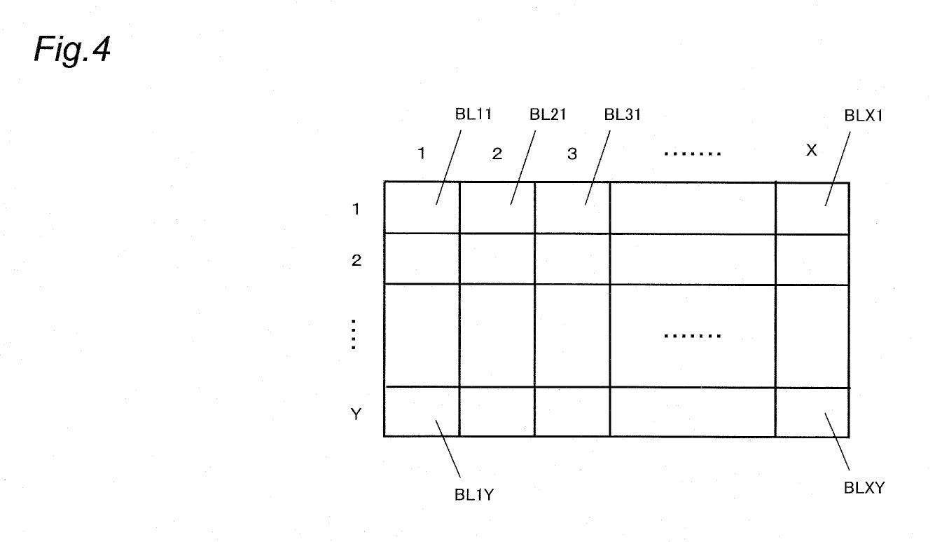

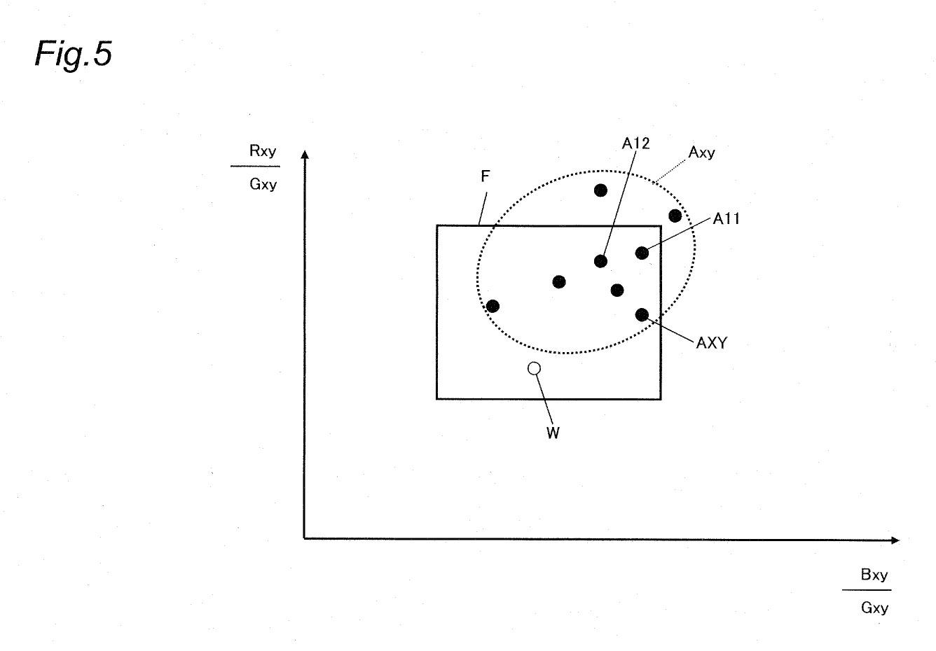

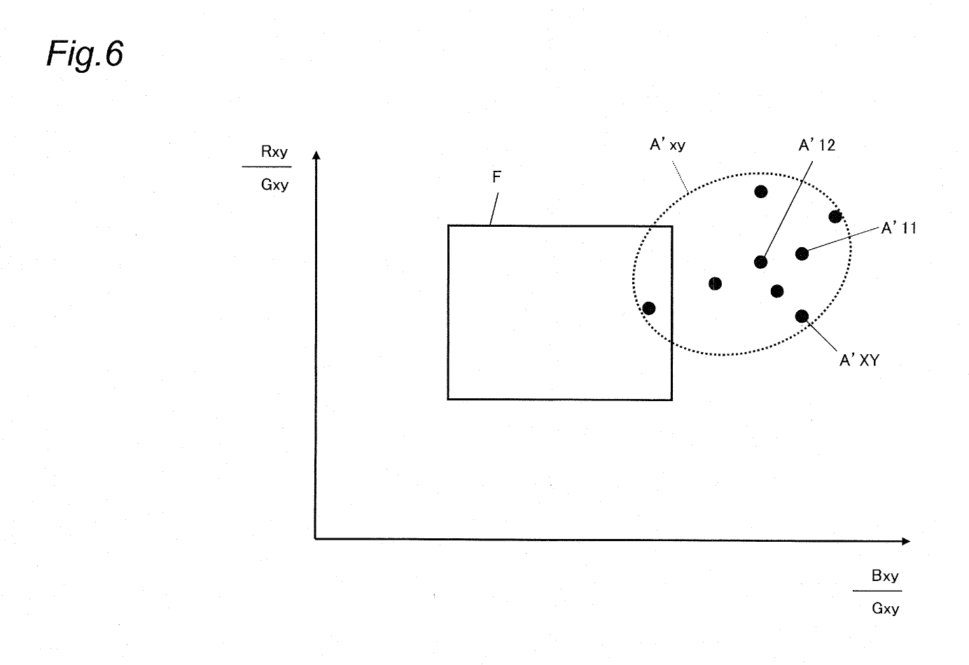

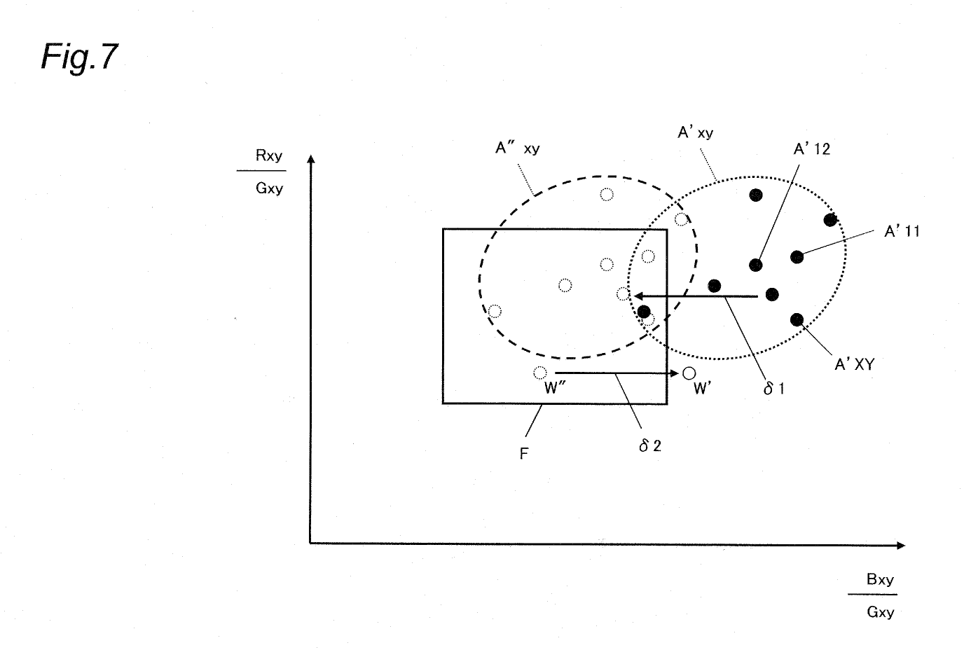

An auto white balance control in the digital video camera 100 according to the embodiment will be described with reference to FIGS. 3 to 7. FIG. 3 is a flowchart for describing a control process of an auto white balance process. FIG. 4 is a schematic diagram describing division of video data. FIG. 5 is a diagram for describing calculation of a position of white in a 2D video signal. FIG. 6 is a diagram for describing calculation of a position of white in a 3D video signal (1), and FIG. 7 is a diagram for describing the calculation of the position of white in the 3D video signal (2).

With reference to FIG. 3, when a user sets the digital video camera 100 into a shooting mode (S100), a controller 210 determines whether the 3D conversion lens 500 is attached to the digital video camera 100 based on a signal from the detection switch 290 (S110). When the determination is made that the 3D conversion lens 500 is not attached, the controller 210 executes the auto white balance process for a 2D video signal (S120 to S140).

Concretely, the controller 210 determines a position of white (S120). The position of white is a position (coordinate) of a coordinate system (horizontal axis: B/G, vertical axis: R/G) shown in FIG. 5 relating to colors that are sensed as white by human under a light source during photographing. The determination of the position of white will be concretely described below.

An image processor 190 divides video data of a subject created by the CCD image sensor 180 into blocks BL11, BL21, BL31, . . . , BLX1, . . . , BL1Y, . . . , BLXY composed of X blocks horizontal by Y blocks vertical as shown in FIG. 4. The image processor 190 calculates an average value of data relating to color intensity (luminosity) recorded in a plurality of pixels included in the blocks BLxy (x=1 to X, y=1 to Y) according to red pixels, green pixels and blue pixels, and outputs the average value to the controller 210. The average value of the color intensity (luminosity) of a plurality of red pixels included in the block BLxy in horizontally x-th bloc and vertically y-th block is “average red data Rxy”. The average value of the color intensity (luminosity) in a plurality of green pixels included in the block BLxy in horizontally x-th and vertically y-th is “average green data Gxy”. The average value of the color intensity (luminosity) in a plurality of blue pixels included in the block BLxy in horizontally x-th and vertically y-th is “average blue data Bxy”. The average red data Rxy, the average green data Gxy and average blue data Bxy are generally called “average color data Hxy”.

The controller 210 calculates Bxy/Gxy, Rxy/Gxy based on the average color data Hxy (Rxy, Gxy, Bxy) of each block BLxy input from the image processor 190. Hereinafter, Bxy/Gxy, Rxy/Gxy is suitably “color data Axy”.

In FIG. 5, the calculated color data Axy is expressed on a coordinate system where Bxy/Gxy is plotted along a horizontal axis and Rxy/Gxy is plotted along a vertical axis. A frame F provided in the coordinate system shown in FIG. 5 is a frame representing a range of color close to white. The controller 210 obtains a position W considered as white in a video represented by the video data, namely, a position of white W based on the color data Axy included in the frame F of the calculated color data Axy. Various methods are known as a method (algorithm) for obtaining the position of white W, and these methods can be utilized.

The controller 210 calculates a gain for adjusting white balance based on the determined position of white W (S130). Concretely, the image processor 190 obtains the gain so that a ratio of intensity (luminosity) among the red pixels, the green pixels and blue pixels is such that (R:G:B)=(1:1:1) on the corrected position of white.

When the gain is calculated, the controller 210 executes the white balance process on video data (data captured from the respective pixels of the CCD image sensor 180) based on the calculated gain (S140).

On the other hand, when it is determined that the 3D conversion lens 500 is attached at step S110, the controller 210 executes the auto white balance process for a 3D video signal on the video data (S150 to S190).

In the 3D conversion lens 500 of the embodiment, a blue component (B) tends to increase further than a red component (R) and a green component (G). For this reason, when the 3D conversion lens 500 is attached and photographing is carried out, the average red data Rxy and average green data Gxy composing the average color data Hxy do not much change, but the average blue data Bxy is enhanced further than the case where photographing is carried out without the 3D conversion lens 500 and thus a bluish color is strong. Therefore, as shown in FIG. 6, the value Bxy/Gxy in Bxy/Gxy and Rxy/Gxy composing the color data Axy calculated based on the average color data Hxy is larger than the case where the 3D conversion lens 500 is not attached, and most of the color data Axy spreads out of the frame F indicating the range close to white. For this reason, the position of white in video data cannot be accurately detected. Therefore, the white balance cannot be satisfactorily adjusted.

Therefore, in the embodiment, the controller 210 corrects each of the color data of a photography image by a color shift amount at the time of attaching the 3D conversion lens 500 (S150). Information about the color shift amount is stored in an internal memory 280 in advance.

Concrete description will be given. The average color data at the time when the 3D conversion lens 500 is not attached is denoted by Hxy, the average red data is denoted by Rxy, the average green data is denoted by Gxy, and the average blue data is denoted by Bxy. The average color data at the time when the 3D conversion lens 500 is attached is represented by H′xy, the average red data is represented by R′xy, the average green data is represented by G′xy, and the average blue data is represented by B′xy. The controller 210 makes a calculation as to the color data Axy, namely, (Bxy/Gxy, Rxy/Gxy) based on the average color data Hxy of each block BLxy. When the 3D conversion lens 500 is attached, a calculation is made as to the color data A′xy, namely, (B′xy/G′xy, R′xy/G′xy) based on the average color data H′xy. When the color data B′xy/G′xy, R′xy/G′xy) at the time when the 3D conversion lens 500 is attached is compared with the color data (Bxy/Gxy, Rxy/Gxy) at the time when the 3D conversion lens 500 is not attached, a shift by a certain amount (α, β) occurs. That is to say, (B′xy/G′xy, R′xy/G′xy)=(Bxy/Gxy+α, Rxy/Gxy+β). Such a color shift occurs because an optical system of the 3D conversion lens 500 has color. The color shift occurs also because of differences in a permeation characteristic and a refraction characteristic of incident light with respect to a wavelength of the incident light in the optical system of the 3D conversion lens 500. Therefore, the controller 210 makes a correction such that, as shown in FIG. 7, the color shift amount (α, β) is subtracted from the color data A′xy at step S150 as shown by an arrow 81. That is to say, the position of the color data A′xy is shifted to a direction of the arrow 81 by the color shift amount (α, β). FIGS. 6 and 7 illustrate an example where β=0. As a result, a lot of the color data are present in the frame F. The controller 210 can obtain the position of white W″ based on each of the corrected color data A″xy by means of algorithm similar to that in the case where the 3D conversion lens 500 is not attached (algorithm at step S120).

When the color shift amount is corrected at step S150, the controller 210 determines the position of white W″ based on the plurality of corrected color data A″xy (S160). In this case, the position of white W″ in the case where the 3D conversion lens 500 is not attached is determined. The process at step S160 is a process similar to the process at step S120. When the position of white W″ in the case where the 3D conversion lens 500 is not attached is calculated, the controller 210 corrects the calculated position of white W″ into the position of white W′ in the case where the 3D conversion lens 500 is attached (S170). Concretely, the controller 210 makes a correction so that the color shift amount (α, β) is added to the position of white (coordinate) W″ as indicated by an arrow δ2 in FIG. 7. Such a correction allows the position of white to shift from W″ to W′ to a direction of the arrow δ2 by the color shift amount (α, β).

When the position of white is corrected into the position of white W′ in the case where the 3D conversion lens 500 is attached, the controller 210 calculates a gain for white balance (S180). Concretely, the controller 210 calculates the gain for making a ratio in intensity (luminosity) among the red pixels, the green pixels and the blue pixels (R:G:B)=(1:1:1) on the corrected position of white W′.

When the gain is calculated, the controller 210 executes the white balance process on video data based on the calculated gain (S190).

Reasons to correct the position of white W″ into the position of white W′ in the case where the 3D conversion lens 500 is attached and calculate the gain based on the corrected position of white W′ will be described. If the position of white W″ is not corrected and the gain for white balance is calculated, the controller 210 executes the white balance process using a gain suitable for the case where the 3D conversion lens 500 is not attached. As a result, a color of the optical system of the 3D conversion lens 500 remains on a recording image. Therefore, in the digital video camera 100 according to the embodiment, the position of white W″ obtained based on the corrected color data A″xy is corrected into the position of white W′ in the case where the 3D conversion lens 500 is attached, and the gain is calculated based on the corrected position of white W′.

4. Conclusion

The digital video camera 100 according to the first embodiment includes the CCD image sensor 180 for capturing a subject image and generating video data, the controller 210 and the image processor 190 for executing the white balance process on the video data generated by the CCD image sensor 180 based on a predetermined algorithm, and the connecting portion 640 connectable with the 3D conversion lens 500 that can simultaneously form a subject image for left eye and a subject image for right eye on the CCD image sensor 180. The controller 210 executes the white balance process based on different algorithms according to whether the 3D conversion lens 500 is connected to the connecting portion 640.

Such a configuration enables the white balance process to be executed based on different algorithms according to whether the 3D conversion lens 500 is connected to the connecting portion 640 or not. As a result, the optimum white balance process can be executed regardless of whether the 3D conversion lens 500 is attached.

Further, in the digital video camera 100 of the first embodiment, when the 3D conversion lens 500 is not connected to the connecting portion 640, the controller 210 executes the white balance process based on a first algorithm, and when the 3D conversion lens 500 is connected to the connecting portion 640, the controller 210 executes the white balance process based on a second algorithm. The process based on the first algorithm includes the process (S120) for extracting the color data Axy included in the region indicated by the frame F set on a color coordinate system where Bxy/Gxy is plotted along the horizontal axis and Rxy/Gxy is plotted along the vertical axis in the color data Axy of the video data and calculating the position of white W based on the extracted color data Axy, the process (S130) for calculating a gain for the white balance process based on the calculated position of white W, and the process (S140) for adjusting the white balance of video data based on the calculated gain. The process based on the second algorithm includes the process (S150) for correcting a position of the color data A′xy of video data where color shift occurs due to the 3D conversion lens 500 in the color coordinate system so that the color shift is resolved, the process (S160) for extracting the color data A″xy included in the region represented by the frame F set on the color coordinate system from the corrected color data A″xy and calculating the position of white based on the extracted color data A″xy, a process (S170) for correcting the calculated position of white W″ into the position W′ according to a color shift, a process (S180) for calculating a gain for the white balance process based on the corrected position of white W′, and a process (S190) for adjusting white balance with respect to video data based on the calculated gain.

With such a configuration, steps S120, S130 and S140 using the first algorithm and steps S160, S180 and S190 using the second algorithm can be configured commonly. The difference is only that steps S150 and S170 are present in the second algorithm. For this reason, the white balance process for a 2D video signal and the white balance process for a 3D video signal where a color shift occurs due to the attachment of the 3D conversion lens 500 can be configured commonly as much as possible. As a result, the attachment of the 3D conversion lens 500 enables a method of a conventional white balance process for a 2D video signal to be effectively used in the white balance process for a 3D video signal where color shift occurs.

### Second Embodiment

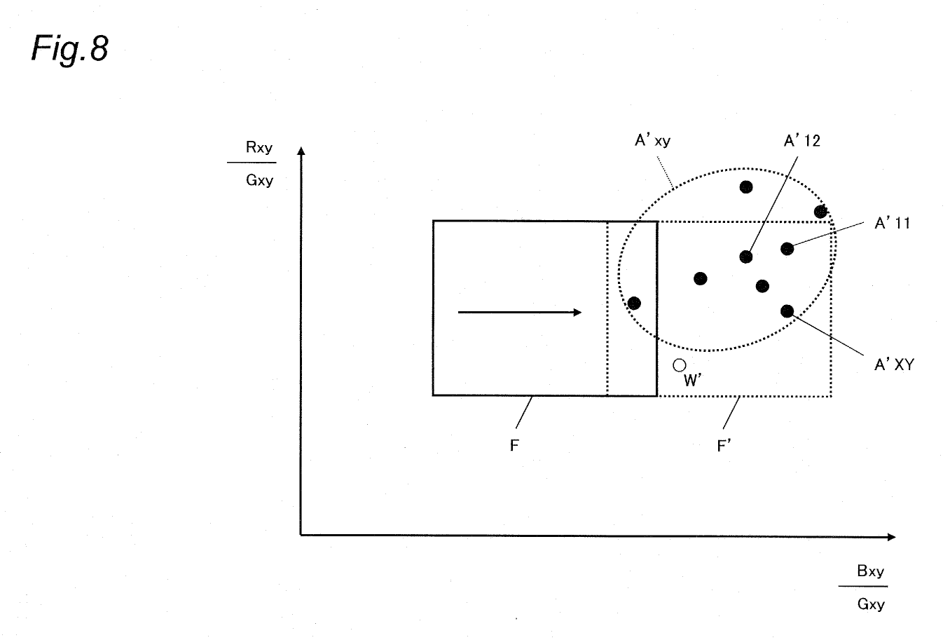

Another embodiment where the present invention is applied to the digital video camera will be described with reference to the drawings. FIG. 8 is a diagram for describing the calculation of the position of white in a 3D video signal in the digital video camera according to the second embodiment. In the first embodiment, when the position of white is calculated, the color data is shifted (the position of the color data is corrected), but in the second embodiment, when the position of white is calculated, the color data Axy is not shifted, but as shown in FIG. 8, the frame F indicating the range close to white is shifted (the position of the frame F is corrected).

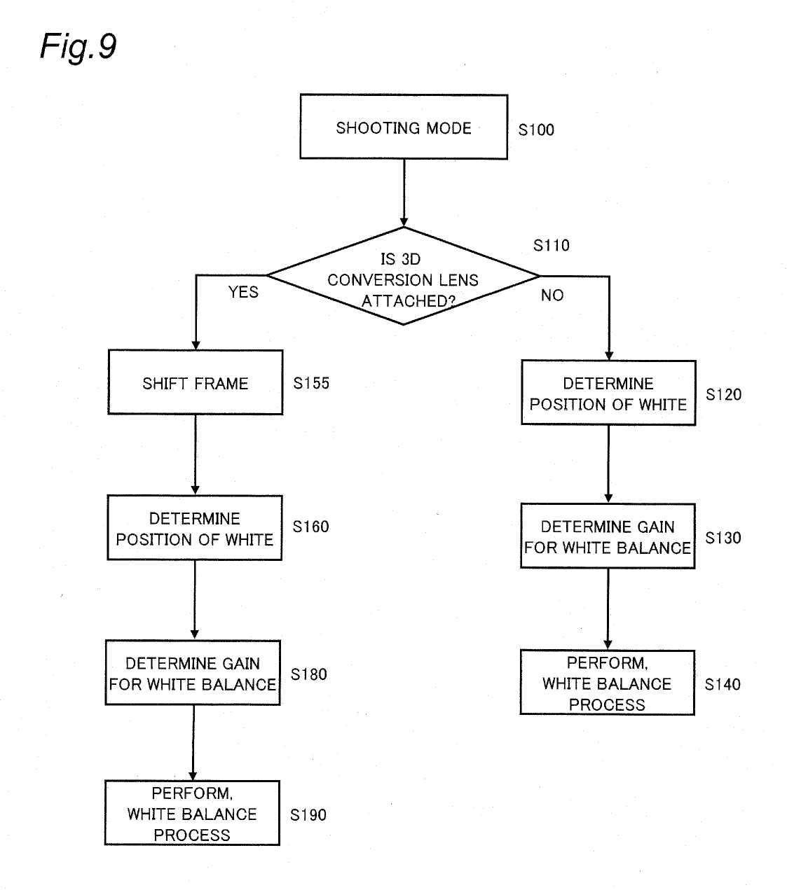

FIG. 9 is a flowchart for describing an auto white balance control process according to a second embodiment. In the white balance process for a 3D video according to the second embodiment, steps S150 and S170 in the white balance process for 3D video in the first embodiment are not executed, and step S155 is added. At step S155, as shown in FIG. 8, the frame F indicating the range close to white is shifted to a predetermined direction by a predetermined amount (the frame F′). This predetermined direction is a direction opposite to the direction to which the color data is shifted in the first embodiment, and the predetermined amount is the same amount (α, β) as that in the first embodiment. FIG. 8 illustrates an example where β=0. At step S155, when the frame F indicating the range close to white is shifted as described above, the shifted frame F′ includes a lot of the color data A′xy of the image photographed with the 3D conversion lens 500 being attached. As a result, the white balance process can be satisfactorily executed. Steps S100 to S140, and S160 to S180 are similar to steps S100 to S180 in the first embodiment, and thus description thereof is omitted.

In such a manner, in the digital video camera 100 according to the second embodiment, when the 3D conversion lens 500 is not connected to the connecting portion 640, the controller 210 executes the white balance process based on the first algorithm, and when the 3D conversion lens 500 is connected to the connecting portion 640, the controller 210 executes the white balance process based on the second algorithm. The process based on the first algorithm is similar to the case of the first embodiment (see FIG. 5). The process based on the second algorithm includes the process (S155) for shifting the region indicated by the frame F set on the color coordinate system composed of Bxy/Gxy plotted along the horizontal axis and Rxy/Gxy plotted along the vertical axis according to a color shift of the color data A′xy caused by the connection of the 3D conversion lens 500, a process (S160) for extracting the color data A′xy included in the shifted region indicated by the frame F′ in the color data A′xy and calculating a position of white W′ calculated based on the extracted color data A′xy, a process (S180) for calculating a gain for the white balance process based on the calculated position of white W′, and a process (S190) for adjusting white balance with respect to video data based on the calculated gain.

According to such a configuration, steps S120, S130 and S140 of the first algorithm, and steps S160, S180 and S190 of the second algorithm can be configured commonly. A different point is only that step S155 is present in the second algorithm. For this reason, the white balance process for a 2D video signal and the white balance process for a 3D video signal where a color shift occurs due to the attachment of the 3D conversion lens 500 can be configured commonly as much as possible. As a result, when the 3D conversion lens 500 is mounted, a conventional method of the white balance process for a 2D video signal can be effectively used in the white balance process for a 3D video signal where the color shift occurs.

### Another Embodiment

As the embodiments of the present invention, the first and second embodiments are described. However, the present invention is not limited to them. Another embodiment of the present invention will be described collectively here.

The above embodiments describe a case where the blue component (B) tends to be bigger than the red component (R) and the green component (G) due to the characteristic of the optical system of the 3D conversion lens 500, but the present invention is not limited to this. For example, the present invention can be applied to a case where any one or two of the red component (R), the green component (G) and the blue component (B) is/are comparatively larger or smaller than the other one(s) due to the characteristic of the optical system of the 3D conversion lens 500. That is to say, the present invention can be widely applied to a case where the balances of the red component (R), the green component (G) and the blue component (B) are equal to each other due to the characteristic of the optical system of the 3D conversion lens 500.

The optical system and a driving system of the digital video camera 100 are not limited to those shown in FIG. 1. FIG. 1 illustrates the example of the optical system composed of three groups, but it may be composed of another groups. Further, each of the lenses may be composed of one lens or a lens group including a plurality of lenses.

The above embodiments illustrate the CCD image sensor 180 as an imaging unit, but the present invention is not limited to this. For example, the sensor may be composed of a CMOS image sensor or an NMOS image sensor.

The above embodiments cope with the color shift in the case where the 3D conversion lens is connected, but the present invention can cope with also the color shift in a case where a teleconversion lens or a wide conversion lens is connected.

### INDUSTRIAL APPLICABILITY

The present invention can be applied to the imaging apparatus such as a digital video camera and a digital still camera.

### DESCRIPTION OF REFERENCE CHARACTERS

100 digital video camera
110 zoom lens
120 detector
130 zoom motor
140 OIS
150 OIS actuator
160 detector
170 focus lens
180 CCD image sensor
190 image processor
200 memory
210 controller
220 gyro sensor
230 card slot
240 memory card
250 operation member
260 zoom lever
270 liquid crystal display monitor
280 internal memory
290 detection switch
640 connecting portion

1. An imaging apparatus connectable with a conversion lens, comprising:
an imaging element that captures a subject image and generates video data having an occurrence of a color shift due to the conversion lens;
an image processor that executes a white balance process on the video data generated by the imaging element based on a predetermined algorithm;
a connecting portion connectable with the conversion lens; and
a detector that detects whether the conversion lens is connected to the connecting portion,
wherein the image processor executes the white balance process based on different algorithms in a case where the conversion lens is connected to the connecting portion and a case where the conversion lens is not connected to the connecting portion according to a detected result of the detector.

2. The imaging apparatus according to claim 1, wherein
when the conversion lens is not connected to the connecting portion, the image processor executes the white balance process based on a first algorithm, and when the conversion lens is connected to the connecting portion, the image processor executes the white balance process based on a second algorithm,
the process based on the first algorithm includes:
a process for extracting color data included in a predetermined region set on a predetermined color coordinate system from color data of the video data and calculating a position of white based on the extracted color data,
a process for calculating a gain for the white balance process based on the calculated position of white, and
a process for adjusting white balance with respect to the video data based on the calculated gain,
the process based on the second algorithm includes:
a process for correcting a position of the color data of the video data where a color shift occurs due to the conversion lens in the predetermined color coordinate system so that the color shift is resolved,
a process for extracting a color data included in the predetermined region set on the predetermined color coordinate system from the corrected color data and calculating a position of white based on the extracted color data,
a process for correcting the calculated position of white according to the color shift,
a process for calculating a gain for the white balance process based on the corrected position of white, and
a process for adjusting white balance with respect to the video data based on the calculated gain.

3. The imaging apparatus according to claim 1, wherein
when the conversion lens is not connected to the connecting portion, the image processor executes the white balance process based on a first algorithm, and when the conversion lens is connected to the connecting portion, the image processor executes the white balance process based on a second algorithm,
the process based on the first algorithm includes:
a process for extracting color data included in a predetermined region set on a predetermined color coordinate system from color data of the video data and calculating a position of white based on the extracted color data,
a process for calculating a gain for the white balance process based on the calculated position of white, and
a process for adjusting white balance of the video data based on the calculated gain,
the process based on the second algorithm includes:
a process for shifting a predetermined region set on a predetermined color coordinate system according to the color shift of the color data of the video data caused due to the conversion lens,
a process for extracting a color data included in the shifted predetermined region in the color data of the video data and calculating a position of white based on the extracted color data,
a process for calculating a gain for the white balance process based on the calculated position of white, and
a process for adjusting white balance of the video data based on the calculated gain.

4. An imaging apparatus connectable with a conversion lens, comprising:
an imaging element that captures a subject image and generates video data having an occurrence of a color shift due to the conversion lens; and
an image processor that executes a white balance process on the video data generated by the imaging element,
wherein the process executed by the image processor includes:
a process for correcting a position of the color data of the video data where a color shift occurs due to the conversion lens in the predetermined color coordinate system so that the color shift is resolved,
a process for extracting a color data included in the predetermined region set on the predetermined color coordinate system from the corrected color data and calculating a position of white based on the extracted color data,
a process for correcting the calculated position of white according to the color shift,
a process for calculating a gain for the white balance process based on the corrected position of white, and
a process for adjusting white balance with respect to the video data based on the calculated gain.

5. An imaging apparatus connectable with a conversion lens, comprising:
an imaging element that captures a subject image and generates video data having an occurrence of a color shift due to the conversion lens; and
an image processor that executes a white balance process on the video data generated by the imaging element,
wherein the process executed by the image processor includes:
a process for shifting a predetermined region set on a predetermined color coordinate system according to the color shift of the color data of the video data caused due to the conversion lens,
a process for extracting a color data included in the shifted predetermined region in the color data of the video data and calculating a position of white based on the extracted color data,
a process for calculating a gain for the white balance process based on the calculated position of white, and
a process for adjusting white balance of the video data based on the calculated gain.

6. An imaging system comprising the imaging apparatus according to claim 1 and the conversion lens which can be connected to the imaging apparatus.

7. An imaging system comprising the imaging apparatus according to claim 4 and the conversion lens which can be connected to the imaging apparatus.

8. An imaging system comprising the imaging apparatus according to claim 5 and the conversion lens which can be connected to the imaging apparatus.
